(19) United States
(12) Patent Application Publication
(10) Pub. No.: US 2007/0262733 A1
(43) Pub. Date: Nov. 15, 2007

(54) Control method and control driving device for backlight module

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/798,274

(22) Filed: May 11, 2007

(30) Foreign Application Priority Data
May 12, 2006 (TW) 095117034

(51) Int. Cl. H05B 39/00

(52) U.S. Cl. 315/312

(57) ABSTRACT

A control method for a backlight module having a driving circuit and at least one lighting element includes the steps of controlling the driving circuit to drive the lighting element according to a first-type control signal before a first time instant, controlling the driving circuit to drive the lighting element according to a transition modulation signal at a time instant between the first time instant and a second time instant, and controlling the driving circuit to drive the lighting element according to a second-type control signal after the second time instant.

### CROSS REFERENCE TO RELATED APPLICATIONS

This Non-provisional application claims priority under 35 U.S.C. §119(a) on Patent Application No(s). 095117034 filed in Taiwan, Republic of China on May 12, 2006, the entire contents of which are hereby incorporated by reference.

### BACKGROUND OF THE INVENTION

1. Field of Invention

The invention relates to a control method and a control driving device for a backlight module. In particular, the invention relates to a control method and a control driving device for a flickering backlight module.

2. Related Art

A flat panel display, such as a liquid crystal display (LCD), does not have the active lighting ability, and thus has to operate in conjunction with a light source. However, the LCD is not an impulse-type display, so a retained image may occur when motion pictures are displayed. In order to generate the display effect of the impulse-type display such as that of the cathode ray tube (CRT) display, the light source of the LCD has to flicker according to the video content.

The conventional LCD device mainly includes a backlight module and a liquid crystal display panel. The backlight module includes a controller, a driving circuit and a light source. The controller outputs a control signal to control an output voltage and an output current of the driving circuit and thus to drive the light source to emit light. In order to simulate the impulse-type display effect of the CRT display, the control signal can control the driving circuit so as to turn on and off the light source for emitting blinking light.

FIG. 1 shows waveforms of conventional control signals. As shown in FIG. 1, the controller outputs different types of control signals according to the property of the video content. When the video content originally pertains to a first type, the controller outputs a first-type control signal, which controls the driving circuit such that the light source flickers in a first mode and the effect of displaying the first type of the video content can be enhanced. When the video content is changed from the first type to a second type, the controller outputs a second-type control signal, which controls the driving circuit such that the light source flickers in a second mode and the effect of displaying the second type of the video content can be enhanced. Consequently, the light source can achieve the effect of simulating the impulse type displaying effect of the CRT display, and also can properly flicker with different modes in response to the property of the video content so that the better display effect can be achieved.

However, when the type of the control signal changes with the video content, its frequency, amplitude or duty cycle suddenly changes such that the frequency, amplitude or duty cycle of the flickering light source also suddenly changes. Thus, the observer may observe the frame flicker of the LCD device, and the display effect of the LCD device is deteriorated.

Therefore, it is an important subject to provide a control method and a control driving device for a backlight module that can solve the above mentioned problems.

### SUMMARY OF THE INVENTION

In view of the foregoing, the invention is to provide a control method and a control driving device for a backlight module, in which a display effect can be enhanced.

To achieve the above, the invention discloses a control method for a backlight module having a driving circuit and at least one lighting element. The control method includes the following steps comprising the steps of: controlling the driving circuit to drive the lighting element according to a first-type control signal before a first time instant, controlling the driving circuit to drive the lighting element according to a transition modulation signal at a time instant between the first time instant and a second time instant, and controlling the driving circuit to drive the lighting element according to a second-type control signal after the second time instant.

To achieve the above, the invention also discloses a control driving device for a backlight module. The control driving device includes a control circuit and a driving circuit. The control circuit outputs a first-type control signal before a first time instant, outputs a transition modulation signal at a time instant between the first time instant and a second time instant, and outputs a second-type control signal after the second time instant. The driving circuit is electrically connected to the control circuit. The driving circuit receives the first-type control signal to drive a lighting element before the first time instant, receives the transition modulation signal to drive the lighting element at the time instant between the first time instant and the second time instant, and receives the second-type control signal to drive the lighting element after the second time instant.

As mentioned above, the driving circuit is controlled by different types of control signals in the control method and the control device for the backlight module of the invention. Thus, the flicker of the lighting element may be correspondingly adjusted, and the driving circuit is not directly controlled by the second-type control signal after the driving circuit is not controlled by the first-type control signal. Instead, the driving circuit is firstly controlled by the transition modulation signal and then by the second-type control signal after the driving circuit is not controlled by the first-type control signal. Consequently, it is possible to prevent the frequency, duty cycle or amplitude of the control signal from changing suddenly and thus to prevent the frequency, flickering time or intensity of the flickering light source from changing suddenly after the lighting element is driven by the driving circuit. Thus, the observer cannot easily sense the flicker of the frame, and the brightness of the frame can be easily kept the same so that the display effect can be enhanced.

### BRIEF DESCRIPTION OF THE DRAWINGS

The invention will become more fully understood from the detailed description given herein below illustration only, and thus is not limitative of the present invention, and wherein:

FIG. 1 shows waveforms of conventional control signals;

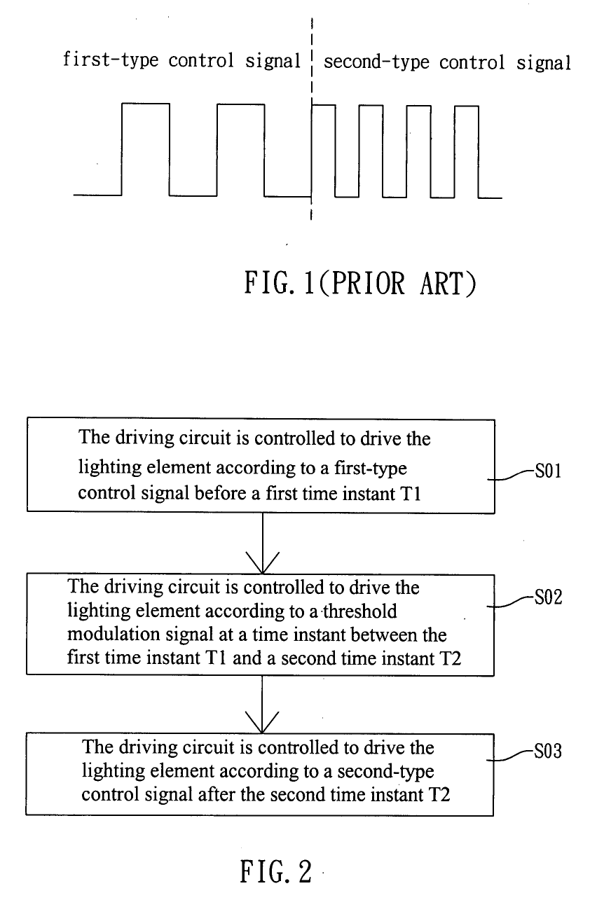

FIG. 2 is a flow chart of a driving method for a backlight module according to a preferred embodiment of the invention;

FIGS. 3 to 4 show waveforms of signals in the driving method for the backlight module according to the preferred embodiment of the invention; and

FIG. 5 is a block diagram showing a control driving device for the backlight module according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

Generally speaking, a backlight module has a lightbox, at least one lighting element, a control circuit and a driving circuit. The lighting element is disposed in the lightbox. The control circuit controls the driving circuit to operate so that the driving circuit drives the lighting element to emit light. If the lighting element is a cold cathode fluorescent lamp, the driving circuit is usually an inverter.

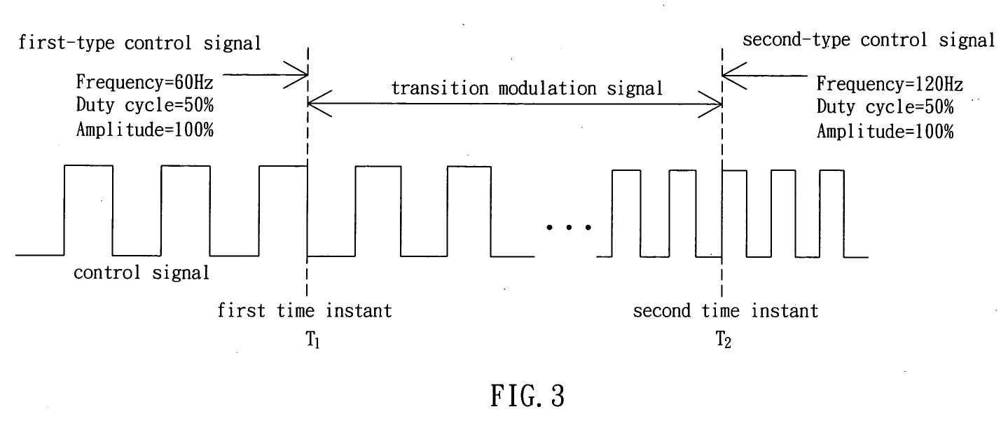

FIG. 2 is a flow chart showing a driving method for a backlight module according to a preferred embodiment of the invention. Referring to FIG. 2, a control method for the backlight module includes steps S01 to S03. First, in step S01, the driving circuit is controlled to drive the lighting element according to a first-type control signal before a first time instant T₁. Then, in step S02, the driving circuit is controlled to drive the lighting element according to a transition modulation signal at a time instant between the first time instant T₁ and a second time instant T₂. Next, in step S03, the driving circuit is controlled to drive the lighting element according to a second-type control signal after the second time instant T₂. Thus, before the driving circuit is controlled according to the second-type control signal, it is first controlled according to the transition modulation signal. Consequently, after the lighting element is driven by the driving circuit, it is possible to prevent the frequency, duty cycle or amplitude of the control signal from suddenly changing and thus to prevent the frequency, flickering time or intensity of the flickering light source from suddenly changing.

The first-type control signal, the transition modulation signal and the second-type control signal are generated by the control circuit. Each of the first-type control signal and the second-type control signal is a pulse width modulation (PWM) signal. The transition modulation signal is a PWM signal having a signal property, such as a frequency, a duty cycle or an amplitude, being modulated.

The first-type control signal has a specific frequency, a specific amplitude and a specific duty cycle for controlling the driving circuit. The driving circuit drives the lighting element according to the first-type control signal so that the lighting element flickers in a first mode with a flickering frequency and a flickering brightness controlled by the first-type control signal. Generally speaking, the flickering frequency of the lighting element is an integral number of times of the frame playing rate. Taking the NTSC for example, the frame playing rate is 60 frames per second, and the flickering frequency of the lamp may be 60 Hz, 120 Hz or 180 Hz. Consequently, the observer cannot easily sense the flicker of the backlight module, and the brightness of the frame can be easily kept the same.

The property of the video content may need different flickering modes. When the property of the video content is changed, the driving circuit is firstly controlled by the transition modulation signal and then by the second-type control signal.

The second-type control signal has a specific frequency, a specific amplitude and a specific duty cycle, and controls the driving circuit. The driving circuit drives the lighting element according to the second-type control signal so that the lighting element flickers in a second mode and thus drives the backlight module to flicker in a different mode according to the video content to achieve the better display effect.

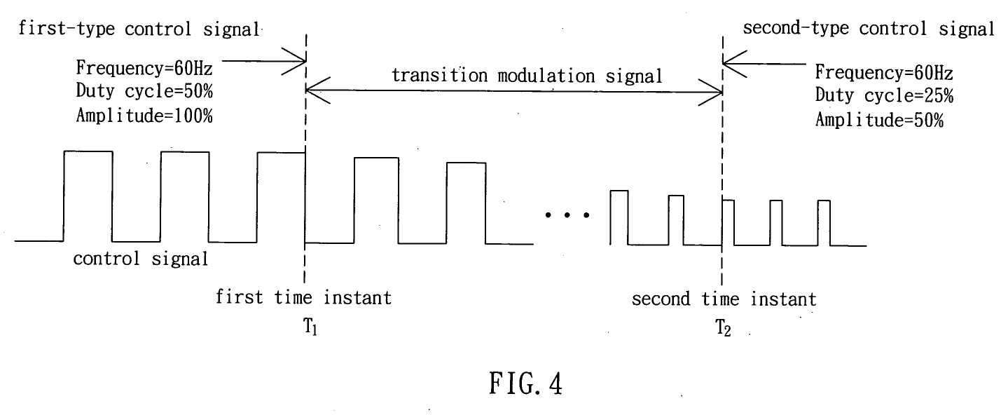

The transition modulation signal is a signal having a signal property, such as a frequency, a duty cycle or an amplitude, being modulated. The signal property of the transition modulation signal is different from the signal property of each of the first-type control signal and the second-type control signal. For example, in FIG. 3, the first-type control signal and the transition modulation signal are mixed with the second-type control signal, and the mixed signal is inputted to the driving circuit. Thus, the driving circuit drives the lighting element according to the first-type control signal before the first time instant T₁, drives the lighting element according to the transition modulation signal at the time instant between the first time instant T₁ and the second time instant T₂, and drives the lighting element according to the second-type control signal after the second time instant T₂.

The frequency of the first-type control signal is 60 Hz, and the frequency of the second-type control signal is 120 Hz. The frequency of each of the two signals is constant. The frequency of the transition modulation signal is modulated from the first type (60 Hz) to the second type (120 Hz) gradually. However, it is to be emphasized that not only the frequency of the transition modulation signal, but also the duty cycle or amplitude of the transition modulation signal can be modulated.

In this embodiment, the initial frequency of the transition modulation signal approaches the frequency of the first-type control signal. Next, the frequency of the transition modulation signal after being modulated gradually approaches the frequency of the second-type control signal. These signals control the driving circuit so that the driving circuit drives the lighting element. Thus, the flickering mode of the lighting element can be gradually changed from the first mode to the second mode, and it is possible to prevent the flickering mode of the lighting element from suddenly changing. Consequently, the observer cannot easily sense the flicker of the lighting element so that the display effect can be enhanced.

In the embodiment, the lighting element may be a cold cathode fluorescent lamp (CCFL) or a light emitting diode (LED).

FIGS. 3 to 4 show waveforms of the signals in the driving method for the backlight module according to the preferred embodiment of the invention. As shown in FIG. 3, the frequency of the transition modulation signal is gradually modulated from 60 Hz to 120 Hz so that the flickering frequency of the lighting element is also gradually changed. Generally speaking, if the video content approximates the stationary picture, the frequency of the control signal is higher. These control signals control the driving circuit to drive the lighting element so that the flickering number of times of the lighting element is greater. On the contrary, if the video content approximates the motion picture, the frequency of the control signal is lower. These control signals control the driving circuit to drive the lighting element so that the flickering number of times of the lighting element is smaller.

In addition, if the video content is changed from the stationary picture to the motion picture, the frequency of the transition modulation signal is gradually decreased. On the contrary, if the video content is changed from the motion picture to the stationary picture, the frequency of the transition modulation signal is gradually increased. Of course, in addition to the frequency, duty cycle or amplitude of the transition modulation signal may also be modulated.

Furthermore, the interval between the first time instant T₁ and the second time instant T₂ is shorter than 500 ms so that the transition modulation signal cannot control the driving circuit for a too long period of time. In addition, it is possible to prevent the second-type control signal from controlling the driving circuit too slowly and thus to prevent the predetermined display effect of the frame from being influenced.

As shown in FIG. 4, the frequency and the duty cycle of the transition modulation signal are modulated by the control circuit. For example, the frequency of the transition modulation signal is gradually modulated from 60 Hz to 120 Hz, the duty cycle thereof is gradually modulated from 50% to 25%, and the amplitude thereof is gradually modulated from 100% to 50%. The frequency of the transition modulation signal is gradually modulated from the frequency of the first-type control signal to the frequency of the second-type control signal, the duty cycle of the transition modulation signal is gradually modulated from the duty cycle of the first-type control signal to the duty cycle of the second-type control signal, and the amplitude of the transition modulation signal is gradually modulated from the amplitude of the first-type control signal to the amplitude of the second-type control signal.

It is to be specified that there is no limitation to the modulation of only one signal property, such as the frequency, the duty cycle or the amplitude, when the transition modulation signal is being modulated. Two or more signal properties may also be modulated simultaneously. In this embodiment, the frequency, the duty cycle and the amplitude are modulated simultaneously. However, it is also possible to modulate the frequency and the duty cycle simultaneously, to modulate the frequency and the amplitude simultaneously, or to modulate the amplitude and the duty cycle simultaneously. The waveform modulating methods are provided to describe the methods of modulating the transition modulation signal without restricting the method of modulating the transition modulation signal to one of the methods described in this embodiment.

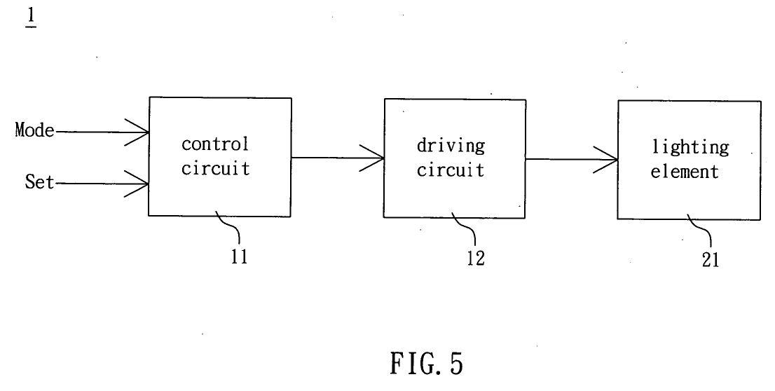

FIG. 5 is a block diagram showing a control driving device 1 for the backlight module according to the preferred embodiment of the invention. Referring to FIG. 5, the control driving device 1 for the backlight module drives a lighting element 21 and includes a control circuit 11 and a driving circuit 12. The control circuit 11 outputs a first-type control signal before a first time instant, outputs a transition modulation signal at a time instant between the first time instant and a second time instant, and outputs a second-type control signal after the second time instant. The driving circuit 12 electrically connected to the control circuit 11 receives the first-type control signal to drive the lighting element 21 before the first time instant, receives the transition modulation signal to drive the lighting element 21 at the time instant between the first time instant and the second time instant, and receives the second-type control signal to drive the lighting element 21 after the second time instant.

These control signals control the output current or voltage of the driving circuit 12. The output current or voltage of the driving circuit 12 drives the lighting element 21 to emit light. The output type of the driving circuit 12 is determined according to the lighting element 21. For example, if the lighting element 21 is a CCFL, the driving circuit 12 must control the output voltage in order to drive the lighting element 21 precisely. If the lighting element 21 is a LED, the driving circuit 12 has to control the output current in order to drive the lighting element 21 precisely.

Generally speaking, the control driving device 1 may be disposed in the backlight module, and the control circuit 11 receives a lighting modulation mode signal Mode, which is outputted from a video processing circuit of a LCD device or a timing control circuit of a liquid crystal panel. The control circuit 11 can know which flickering mode of the lighting element to be changed so that the second-type control signal can be outputted at the second time instant, and the transition modulation signal can be outputted before the second time instant.

The control method mentioned hereinabove may be applied to the control device of this embodiment, and the same references relate to the same elements having the same structures, functions and effects. Therefore, the detailed descriptions thereof will be omitted.

In summary, the driving circuit is controlled by different types of control signals in the control method and the control device for the backlight module of the invention. Thus, the flicker of the lighting element may be correspondingly adjusted, and the driving circuit is not directly controlled by the second-type control signal after the driving circuit is not controlled by the first-type control signal. Instead, the driving circuit is firstly controlled by the transition modulation signal and then by the second-type control signal after the driving circuit is not controlled by the first-type control signal. Consequently, it is possible to prevent the frequency, duty cycle or amplitude of the control signal from changing suddenly and thus to prevent the frequency, flickering time or intensity of the flickering light source from changing suddenly after the lighting element is driven by the driving circuit. Thus, the observer cannot easily sense the flicker of the frame, and the brightness of the frame can be easily kept the same so that the display effect can be enhanced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A method of controlling a backlight module having a driving circuit and at least one lighting element, the method comprising the steps of:
controlling the driving circuit to drive the lighting element according to a first-type control signal before a first time instant;
controlling the driving circuit to drive the lighting element according to a transition modulation signal at a time instant between the first time instant and a second time instant; and
controlling the driving circuit to drive the lighting element according to a second-type control signal after the second time instant.

2. The method according to claim 1, wherein the backlight module further comprises a control circuit for generating the first-type control signal, the transition modulation signal and the second-type control signal.

3. The method according to claim 1, wherein the transition modulation signal is a pulse width modulation (PWM) signal having a frequency being modulated.

4. The method according to claim 3, wherein the frequency of the transition modulation signal is modulated from a frequency of the first-type control signal to a frequency of the second-type control signal.

5. (canceled)

6. (canceled)

7. (canceled)

8. (canceled)

9. The method according to claim 1, wherein an interval between the first time instant and the second time instant is shorter than 500 ms.

10. The method according to claim 1, wherein the lighting element is a cold cathode fluorescent lamp (CCFL) or a light-emitting diode (LED).

11. A control driving device used in a backlight module to drive a lighting element, the control driving device comprising:
a control circuit for outputting a first-type control signal before a first time instant, outputting a transition modulation signal at a time instant between the first time instant and a second time instant, and outputting a second-type control signal after the second time instant; and
a driving circuit, which is electrically connected to the control circuit, for receiving the first-type control signal to drive the lighting element before the first time instant, for receiving the transition modulation signal to drive the lighting element at the time instant between the first time instant and the second time instant, and for receiving the second-type control signal to drive the lighting element after the second time instant.

12. The control driving device according to claim 11, wherein the transition modulation signal is a pulse width modulation (PWM) signal having a frequency being modulated.

13. The control driving device according to claim 12, wherein the frequency of the transition modulation signal is modulated from a frequency of the first-type control signal to a frequency of the second-type control signal.

14. (canceled)

15. (canceled)

16. (canceled)

17. (canceled)

18. The control driving device according to claim 11, wherein an interval between the first time instant and the second time instant is shorter than 500 ms.

19. The control driving device according to claim 11, wherein the lighting element is a cold cathode fluorescent lamp (CCFL) or a light-emitting diode (LED).
